(19) United States
(12) Patent Application Publication
(10) Pub. No.: US 2011/0252559 A1
(43) Pub. Date: Oct. 20, 2011

(54) FIXTURES HAVING POLYMER FORMS

(76) Inventor: Charles E. Dockery, Knoxville, TN (US)

(21) Appl. No.: 13/085,765

(22) Filed: Apr. 13, 2011

Related U.S. Application Data
(60) Provisional application No. 61/324,183, filed on Apr. 14, 2010.
(60) Provisional application No. 61/391,860, filed on Oct. 11, 2010.

(51) Int. Cl. A47K 3/02; A47K 3/28; B32B 27/06; B32B 27/40; B32B 5/18; B05D 3/00; A47K 1/04

(52) U.S. Cl. 4/584; 427/299; 4/612; 4/619; 428/304.4; 428/319.7; 428/159

(57) ABSTRACT

The present invention provides methods for adding a polymer form to a fixture such as a bathtub, shower stall, sink, or toilet, and those articles. The polymer form comprises a rigid foam and a topcoat. The polymer form, in some embodiments, imparts improved performance characteristics such as temperature retention, sound deadening, and rigidity, and can allow a steel fixture to better mimic one made of cast iron at significantly less expense. The fixtures include metal fixtures with and without enamel coatings.

### CROSS REFERENCE TO RELATED APPLICATIONS

This application claims benefit under 35 U.S.C. §119(e) of U.S. Provisional Patent Application No. 61/324,183, filed on Apr. 14, 2010, for “FIXTURES HAVING POLYMER FORMS,” and U.S. Provisional Patent Application No. 61/391,860, filed on Oct. 11, 2010, for “FIXTURES HAVING POLYMER FORMS;” both provisional applications are incorporated herein by reference in their entirety.

### FIELD OF INVENTION

This invention relates to fixtures such as metal fixtures, with or without enamel coating, such as bathtubs, methods for adding polymer forms to those fixtures, and fixtures having polymer forms attached thereto.

### BACKGROUND OF THE INVENTION

Among common plumbing fixtures such as bathtubs, it is desirable to use enamel-coated cast iron because of the material's look, strength, temperature retention, rigidity, and sound deadening characteristics. However, cast iron also has certain drawbacks, namely that it is heavy, hard to work with, and expensive. Accordingly, many plumbing fixtures today employ enamel-coated steel. While generally being lighter and less expensive, the enamel-coated steel fixtures lack the rigidity, strength, “sound,” and other performance characteristics of enamel-coated cast iron. Significantly, the aesthetics of steel-based fixtures are considered inferior to those of the cast iron fixtures.

Applicant has invented methods and combinations of materials to improve the performance characteristics of fixtures such as bathtubs, shower stalls, sinks, and toilets. Certain embodiments of the present invention make it possible for steel-based fixtures to mimic cast iron performance, including aesthetic properties that are important to the end user.

### SUMMARY OF THE INVENTION

In some embodiments of the present invention, Applicant has created methods for adding a polymer form to an enamel-coated metal fixture, comprising obtaining the enamel-coated metal fixture, which comprises a front surface and a back surface; forming a rigid foam on at least a portion of the back surface of the enamel-coated metal fixture; and applying a topcoat to the rigid foam, thereby adding the polymer form to the enamel-coated metal fixture. Other embodiments of the present invention relate to an enamel-coated metal fixture having a front surface and a back surface, comprising, proximal to the back surface, a layer of rigid foam; distal from the back surface, a topcoat on the layer of rigid foam.

Still other embodiments relate to a metal fixture having no enamel having a front surface and a back surface, comprising a layer of rigid foam proximal to the back surface; and a topcoat on the layer of rigid foam distal from the back surface. Similarly, additional embodiments relate to methods for adding a polymer form to a metal fixture, comprising obtaining the metal fixture, which comprises a front surface and a back surface; forming a rigid foam on at least a portion of the back surface of the metal fixture; and applying a topcoat to the rigid foam, thereby adding the polymer form to the metal fixture.

### BRIEF DESCRIPTION OF THE DRAWINGS

FIG. 1 depicts one embodiment of the invention comprising a bathtub that has been cut in half.

FIG. 2 depicts a cross section of the materials making up a section of the floor of the bathtub shown in FIG. 1.

FIG. 3 depicts another embodiment showing a cross section of a bathtub floor comprising materials that differ from those in FIG. 2.

### DETAILED DESCRIPTION

As required, detailed embodiments of the present invention are disclosed herein; however, it is to be understood that the disclosed embodiments are merely exemplary of the invention that may be embodied in various forms. The figures are not necessarily to scale, and some features may be exaggerated to show details of particular components. Therefore, specific structural and functional details disclosed herein are not to be interpreted as limiting, but merely as a basis for the claims and as a representative basis for teaching one skilled in the art to variously employ the present invention.

An enamel-coated metal fixture can be any suitable fixture, or a “blank” for forming an installation-ready fixture, that has a metal form coated with enamel. The metal is any suitable metal, such as, for example, steel, stainless steel, hot rolled steel, cold rolled steel, cast iron, wrought iron, tin, or aluminum, or combinations thereof. The enamel is any suitable enamel, porcelain, ceramic, or the like, such as those routinely used in the manufacture of plumbing fixtures. Similarly, a metal fixture can be any suitable fixture as well, made from one or more of any suitable metal, such as, for example, steel, stainless steel, hot rolled steel, cold rolled steel, cast iron, wrought iron, tin, or aluminum. Metals, as described herein, include elemental metals as well as alloys.

Obtaining a fixture can occur according to any suitable method, such as purchasing or manufacturing according to standard methods. In one standard method of making an enamel-coated metal fixture, steel sheet drawn into the form of a fixture is coated with a frit slurry and fired at about 1500° F.

Generally speaking, the fixture will have at least a front surface and a back surface. To illustrate, a bathtub has a front surface that contacts water and the bather. In several embodiments of the invention, this front surface will not have a polymer form attached to it. The bathtub also has a back surface, which upon installation in a bathroom, is generally hidden from view. It is this back surface, generally speaking, that will have a polymer form attached to it. Suitable fixtures include, but are not limited to, bathtubs, shower stalls, sinks, and toilets.

The rigid foam is any suitable insulating material. In some cases, the rigid foam comprises a material that entraps pockets of air. The foam can be open cell, closed cell, fibrous, or a combination thereof. “Rigid” is to be interpreted broadly, whereby in some cases the foam would substantially hold its shape if it were not attached to the fixture or any other structure, subjected only to the pressure of its own weight. In other cases, the rigid foam imparts significant strength and rigidity to the fixture. Materials suitable as the rigid foam are not limited. Examples include, but are not limited to polyurethane, expanded polystyrene, and extruded polystyrene foam.

Forming the rigid foam on at least a portion of the back surface of the fixture can occur according to any suitable method. A foaming substance or substances can be sprayed or otherwise deposited on the back surface of the fixture, or on a portion thereof, and allowed to set. Then the foam can be carved to the desired shape. Or, forming a rigid foam comprises

(a) placing the fixture into a mold so that the mold and the back surface of the fixture define a space; (b) injection molding one or more rigid foam-forming precursors into the space, optionally under pressure; (c) curing the rigid foam-forming precursor or precursors to form the rigid foam on the back surface; and (d) removing the fixture and rigid foam from the mold. In addition to injection molding foam-forming precursors into the space defined by the mold and the back surface, one may free-pour, vacuum mold, or otherwise introduce the foam-forming material or precursors into the space. Pressure can be any suitable pressure, such as for example at least about 0.1 atm; at least about 1 atm; at least about 5 atm; at least about 10 atm; at least about 50 atm; or at least about 100 atm. Curing the rigid foam-forming precursor or precursors can involve any suitable process, such as, for example, allowing the precursors to react at ambient temperature for a sufficient time; heating; exposing to UV light, or combinations thereof. The rigid foam will adhere to the back surface of the fixture, in some embodiments. In other embodiments, one or more adhesives can be used, either by depositing a layer, a pattern, or spots of adhesive on the back surface before molding. In still other embodiments, some or all of the enamel can be removed from the back surface to facilitate adhesion of the rigid foam, as described below.

A topcoat is a layer, generally a polymer, that imparts one or more characteristic to the rigid foam. In some cases, the topcoat seals the rigid foam. In other cases, the topcoat creates a hard shell that protects the rigid foam from mechanical damage during shipping and installation. In still other cases, the topcoat increases the UV light resistance of the rigid foam. In still other cases, the topcoat can be colored, painted, or textured, to add aesthetic appeal. Applying the topcoat can occur according to any suitable method, such as, for example, brushing, spraying, dipping, swabbing, or combinations thereof. Suitable topcoat materials include, but are not limited to, epoxies and polyurethanes.

The polymer form, comprising the rigid foam and the topcoat, can be disposed on a portion of the back surface of the enamel-coated metal fixture, in some cases. In other cases, the polymer form is disposed on substantially the entire back surface of the fixture. In still other cases, another polymer form of the same or different materials is dispersed on at least a portion of one or more other surfaces of the fixture, optionally including the front surface.

The rigid foam can be present in a single layer, or in a plurality of layers of alike or different materials. Similarly, the topcoat can be present in a single layer, or in a plurality of layers of alike or different materials. In some embodiments, alternating layers of rigid foam and topcoat can appear, to impart special performance characteristics. These layers can be applied, for example, by multiple molding operations.

In some embodiments, applying a topcoat to the rigid foam comprises: (a) depositing polyurethane precursors onto the rigid foam; (b) curing the polyurethane precursors to form a polyurethane topcoat. Polyurethane precursors suitable for the topcoat include, but are not limited to commercially available isocyanates, polyols, and polyureas such as those sold by the Chemline company under the trademark Chemthane®. Depositing the precursors can occur according to any suitable method, such as, for example, dipping, spraying, rubbing, swabbing, brushing, or combinations thereof. Curing the polyurethane precursors can occur according to any suitable method, such as, for example, allowing the precursors to react at ambient temperature for a sufficient time, UV light exposure, heating such as with a heat gun or by the flow of heated air or other gas, catalysis, and combinations thereof.

In some embodiments, one or more sound-deadening pads are attached to the back surface of the fixture. In certain embodiments, that happens before forming the rigid foam. The sound deadening pad can be attached to the back surface of the enamel-coated steel fixture by any suitable means, such as, for example, contact adhesives that are commonly used. A sound deadening pad can cover a portion of the back surface, in certain cases, or a sound deadening pad can cover substantially the entire back surface, in other cases. In still other cases, a plurality of sound-deadening pads can cover at least a portion of the back surface. Sound deadening pads can be any suitable material, such as natural or synthetic rubber, elastomer, foam, wood, expanded polystyrene, fiberglass, glass, structural plastics, metal, gums, and tar, and combinations thereof.

Similarly, in other embodiments, one or more layers, pads, pieces, or bracing elements may appear proximal to the back surface of the enamel-coated metal fixture. These layers, pads, pieces, or bracing elements can comprise any suitable material and serve any desired purpose. Some layers, pads, pieces, or bracing elements serve aesthetic purposes, such as improved sound, rigidity, strength, temperature retention, or the like. Suitable materials include, but are not limited to, natural or synthetic rubber, elastomer, foam, wood, expanded polystyrene, fiberglass, glass, structural plastics, metal, gums, and tar, and combinations thereof.

Further embodiments allow for the improvement of one or more properties as a result of including the polymer form on the fixture. In some embodiments, the at least one improved property is chosen from temperature retention, sound deadening, and rigidity.

Temperature retention can be measured according to any suitable protocol, such as, for example, filling the fixture such as a bathtub to overflow with water having a temperature of 105° F., and measuring time in minutes until the temperature of the water falls to 95° F. In some embodiments, the enamel-coated metal fixture of the present invention will have a temperature retention from 105° F. to 95° F. greater than about 126 minutes based on that test.

Sound deadening can be measured, for example, in accordance with any suitable protocols.

Rigidity can be tested, for example, in accordance with ASME A112.19.4M-1994(R 2004). In that test, a 300 lb. weight is applied to the center of the bathtub (when the fixture is a bathtub) for two minutes and removed. Then, ten minutes later, the weight is reapplied for two minutes and the deflection under load is measured. Once the weight is removed, the residual deflection is measured within ten minutes. The test can be repeated with increasing weights until failure, if desired. Some embodiments of the present invention involve an enamel-coated metal fixture having deflection under a 300 pound load of less than about 0.075″. Other embodiments of the present invention involve an enamel-coated metal fixture having deflection under a 600 pound load of less than about 0.140″, and residual deflection of less than about 0.020″.

For greater adhesion of the rigid foam to the back surface of an enamel-coated metal fixture, some of the enamel can be removed from at least a portion of the back surface of the fixture. The enamel can be removed, for example, with an industrial sander or grinder. In certain cases, the enamel is removed from edges and curves where it is estimated the rigid foam will have the most difficulty adhering to the fixture.

Additional embodiments of the present invention comprise a fixture having a front surface and a back surface, comprising, proximal to the back surface, a layer of rigid foam; and distal from the back surface, a topcoat on the layer of rigid foam. Proximal means “close to,” and in some cases, the layer of rigid foam contacts the back surface. In other cases, the rigid foam contacts another material that contacts the back surface. For example, a sound deadening pad could appear between the rigid foam and the back surface. More than one material is possible between the rigid foam and the back material. Distal means “farther from,” so when the topcoat is distal from the back surface, that indicates that the topcoat is farther from the back surface. It need not be the farthest layer, but in several cases it is.

Other embodiments of the present invention involve a fixture that is self-leveling. A self-leveling fixture such as a bathtub would offer installers and end users great advantage, because many fixtures naturally have some warpage. Applicant has found unexpectedly that it is possible to design the mold to accommodate any warpage in the fixture to which the polymer form is affixed. Considering bathtubs, for example, warpage can be accounted for by aligning the mold off of the apron, which is the portion of the tub body that one steps over to get in the tub. Thus, when the bathtub is removed from the mold and a topcoat is applied, the tub can rest level on its own. Accordingly, further embodiments involve methods for making a fixture that self-levels by molding the rigid foam taking into account any warpage of the fixture.

Still other embodiments allow for a visible imprint to be present in the rigid foam. The visible imprint could be any suitable design, such as, for example, a logo, a trademark, or an artistic pattern. The visible imprint can be formed by any suitable method, such as, for example, by including the imprint in the mold, or by carving the rigid foam once molded. Suitable artistic patterns include, but are not limited to, geometric patterns, lines, shapes, figures such as dolphins or other animals or characters, bumps for example resembling waves, divots for example resembling ripples, and the like. In some additional embodiments, the topcoat can be colored or painted. Thus in certain cases, a front surface of a fixture can have an appearance given by the enamel, and an appearance from the back surface given by the polymer form.

### DETAILED DESCRIPTION OF THE DRAWINGS

Further embodiments of the present invention can be described by reference to the accompanying drawings.

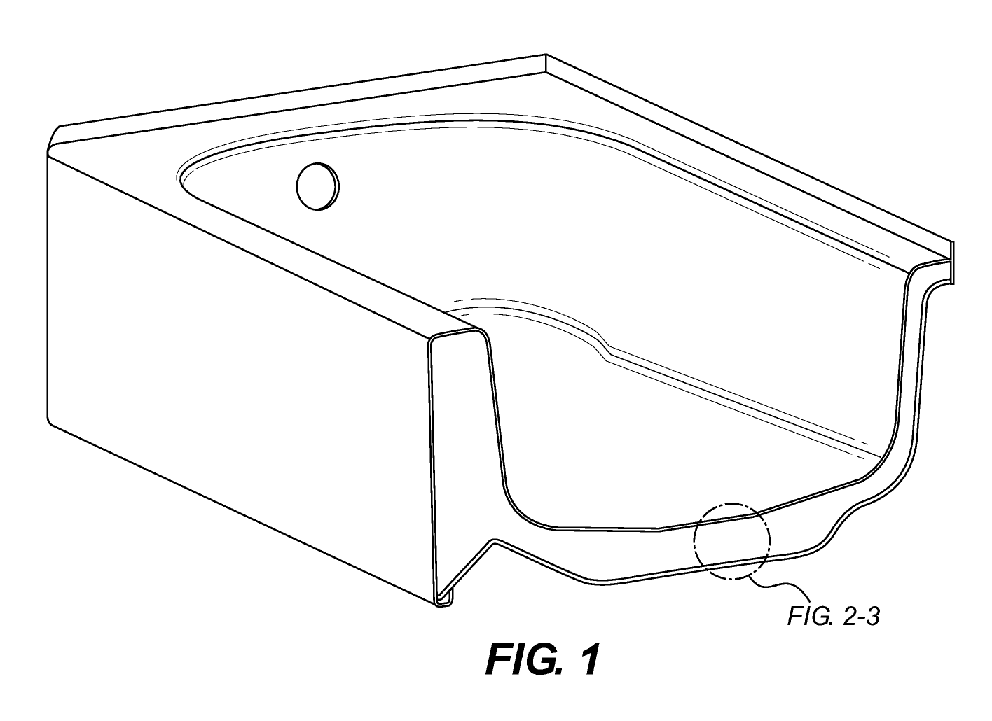

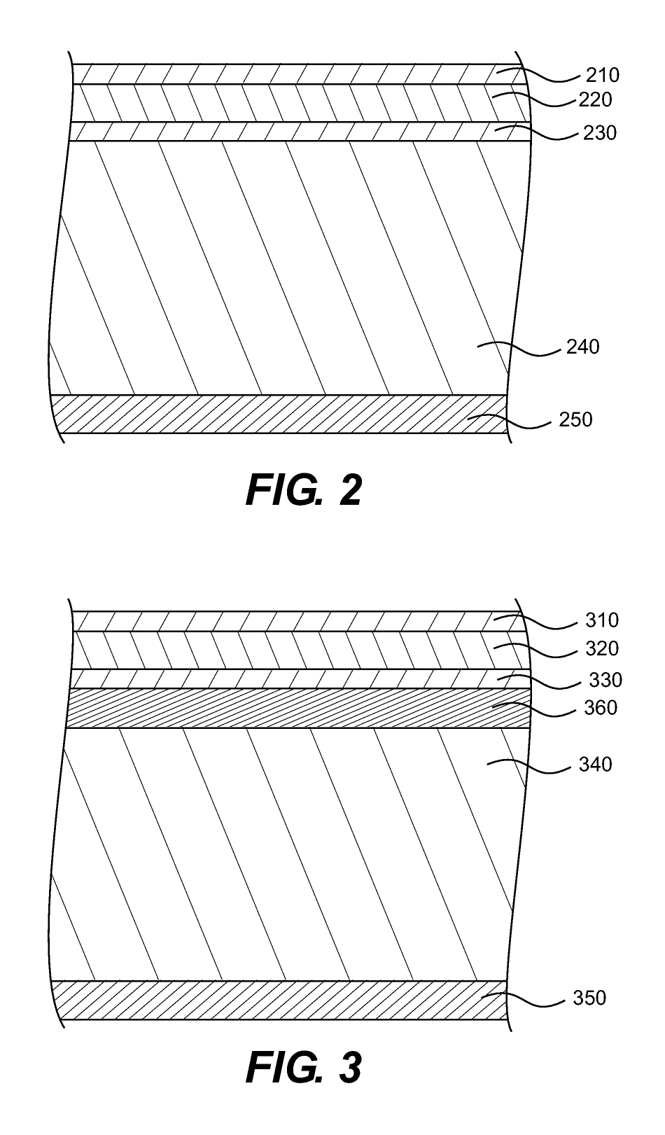

FIG. 1 shows one embodiment of the invention, a bathtub cut in half in perspective view. The circle indicates the cross-section of materials shown in FIGS. 2 and 3.

FIG. 2 shows a cross-section of the materials forming one embodiment of the present invention. Steel 220 coated with enamel 210, 230 forms the general shape of a bathtub. The front surface of the bathtub comprises enamel 210, while the back surface of the bathtub comprises enamel 230. Adhered to back surface enamel 230 is a rigid foam 240. Capping and sealing the rigid foam 240 is topcoat 250. The polymer form comprises rigid foam 240 and topcoat 250.

FIG. 3 shows a cross-section of the materials forming another embodiment of the invention. Steel 320 coated with enamel 310 and 330 forms the shape of a bathtub. Adhered to the back surface enamel 330 is a sound-deadening pad 360. Then, on the sound-deadening pad 360 appear a rigid foam 340, and a topcoat 350. Here, the polymer form comprises the sound-deadening pad 360, the rigid foam 340, and the topcoat 350.

### EXAMPLES

### Example 1

### Rigidity Test

An enamel-coated steel bathtub was made in accordance with the present invention, having a polyurethane rigid foam made from Autofroth® polyurethane precursors available from BASF injection molded with nitrogen at 80 psi. The polyurethane topcoat was made from Chemthane® available from Chemline sprayed onto the rigid foam after demolding. A rigidity test was performed as described above, measuring deflection under load and residual deflection at various weights from 300 lbs. to 600 lbs. Results are shown in

TABLE 1
Deflection Test

| | Deflection under Load | Residual Deflection |
|---|---|---|
| Load (lbs.) | (inches) | (inches) |
| 300 | 0.072 | 0.000 |
| 350 | 0.075 | 0.000 |
| 410 | 0.080 | 0.005 |
| 470 | 0.094 | 0.006 |
| 520 | 0.115 | 0.006 |
| 585 | 0.119 | 0.009 |
| 600 | 0.128 | 0.010 |

The data in Table 1 show the tested bathtub performed very well in the rigidity test. Maximum residual deflection after 300 lbs. allowed by ASME A112.19.4M is 0.003″, and this bathtub exhibited 0.000″ residual deflection.

### Example 2

### Temperature Retention with Competitors' Bathtubs

In this experiment, a bathtub made in accordance with the present invention was tested against two competitor's bathtubs. All bathtubs were approximately 60″×30″×14″, and were filled to overflow with water having a temperature of 105° F. The time it took for the water to cool to 95° F. was measured. Results appear in Table 2.

TABLE 2
Time to Cool from 105° F. to 95° F.

| Location of T | | | |
|---|---|---|---|
| Measurement | Briggs (Invention) | Competitor 1 | Competitor 2 |
| Near Drain | 132 minutes | 126 minutes | 118.5 minutes |
| Back of Tub | 130 minutes | 122 minutes | 116.2 minutes |

The foregoing dramatically demonstrates the superior temperature retention of a bathtub made according to the present invention compared to two commercially-available bathtubs.

As previously stated, detailed embodiments of the present invention are disclosed herein; however, it is to be understood that the disclosed embodiments are merely exemplary of the invention that may be embodied in various forms. It will be appreciated that many modifications and other variations stand within the intended scope of this invention as claimed below. Furthermore, the foregoing description of various embodiments does not necessarily imply exclusion. For example, “some” embodiments may include all or part of “other” and “further” embodiments within the scope of this invention. In addition, “a” does not mean “one and only one;” “a” can mean “one and more than one.”

I claim:

1. A method of adding a polymer form to a fixture, comprising:
obtaining the fixture, which comprises a front surface and a back surface;
forming a rigid foam on at least a portion of the back surface of the fixture; and
applying a topcoat to the rigid foam, thereby adding the polymer form to the fixture.

2. The method of claim 1, wherein the fixture is chosen from bathtubs, shower stalls, sinks, and toilets.

3. The method of claim 2, wherein the fixture is a bathtub.

4. The method of claim 1, wherein forming a rigid foam comprises:
(a) placing the fixture into a mold so that the mold and the back surface of the fixture define a space;
(b) injection molding one or more rigid foam-forming precursors into the space, optionally under pressure;
(c) curing the rigid foam-forming precursor or precursors to form the rigid foam on the back surface; and
(d) removing the fixture and rigid foam from the mold.

5. The method of claim 1, wherein applying a topcoat to the rigid foam comprises:
(a) depositing polyurethane precursors onto the rigid foam;
(b) curing the polyurethane precursors to form a polyurethane topcoat.

6. The method of claim 1, wherein the polymer form substantially covers the back surface.

7. The method of claim 1, further comprising, before forming the rigid foam, attaching one or more sound-deadening pads to the back surface.

8. The method of claim 1, wherein the fixture having the polymer form has at least one property improved relative to the fixture.

9. The method of claim 8, wherein the at least one improved property is chosen from temperature retention, sound deadening, and rigidity.

10. The method of claim 1, further comprising, before forming a rigid foam, removing enamel from at least a portion of the back surface of the fixture.

11. The method of claim 1, wherein the fixture is an enamel-coated metal fixture.

12. The method of claim 1, wherein the fixture is a metal fixture.

13. A fixture having a front surface and a back surface, comprising:
proximal to the back surface, a layer of rigid foam;
distal from the back surface, a topcoat on the layer of rigid foam.

14. The fixture of claim 13, further comprising:
a sound-deadening pad between the back surface and the layer of rigid foam.

15. The fixture of claim 13, wherein the rigid foam comprises polyurethane.

16. The fixture of claim 13, wherein the at least one topcoat comprises polyurethane.

17. The fixture of claim 13, chosen from bathtubs, shower stalls, sinks, and toilets.

18. The fixture of claim 17, wherein the fixture is a bathtub.

19. The fixture of claim 18, having deflection under a 300 pound load of less than about 0.075″.

20. The fixture of claim 18, having deflection under a 600 pound load of less than about 0.140″, and residual deflection of less than about 0.020″.

21. The fixture of claim 18, having temperature retention from 105° F. to 95° F. greater than about 126 minutes.

22. The fixture of claim 13, wherein the fixture is self-leveling.

23. The fixture of claim 13, further comprising a visible imprint appearing in the rigid foam.

24. The fixture of claim 13, wherein the fixture is an enamel-coated metal fixture.

25. The fixture of claim 13, wherein the fixture is a metal fixture.
